(19) United States
(12) Patent Application Publication
(10) Pub. No.: US 2016/0119730 A1
(43) Pub. Date: Apr. 28, 2016

(54) METHOD FOR IMPROVING AUDIO QUALITY OF ONLINE MULTIMEDIA CONTENT

(71) Applicant: Project Aalto Oy, Helsinki (FI)

(72) Inventor: Marko Virtanen, Helsinki (FI)

(21) Appl. No.: 14/791,975

(22) Filed: Jul. 6, 2015

Related U.S. Application Data
(60) Provisional application No. 62/021,529, filed on Jul. 7, 2014.

(51) Int. Cl. H04R 29/00; H04R 3/04; G06F 3/16

(52) U.S. Cl. CPC H04R 29/001; G06F 3/165; H04R 3/04; H04R 2430/01

(57) ABSTRACT

Disclosed is a method for improving audio quality of online multimedia content. The method includes sending an input audio sample to at least one speaker positioned within a premises, playing the input audio sample at the at least one speaker to produce a corresponding audio, recording the audio produced by the at least one speaker as a recorded audio sample at a multimedia processing device positioned in a proximity of the at least one speaker, comparing the recorded audio sample with the input audio sample for calculating acoustical characteristics of the premises and adjusting an audio quality of an online multimedia content to be played within the premises based on the calculated acoustical characteristics.

### TECHNICAL FIELD

The present disclosure relates to processing of online multimedia content, and more specifically, relates to improving audio quality of the online multimedia content.

### BACKGROUND

In recent times, streaming music has gained huge popularity and has outnumbered physical media and MP3 players. There are several online service providers, such as Spotify® and Internet radio stations, which provide audio on demand and streaming services in general. Also, there are several online service providers, such as NETFLIX® and YOUTUBE®, which provide audio as part of video stream. Generally, users have audio systems at home which are used to play audio of such online multimedia content. An example of an audio system includes loudspeakers of the television set which is used to play video on demand service. Another example is stereo system in a living room which is used to play music from an audio on demand service.

However, the room where the audio is played and the equipment playing the audio, alters the original sound and add anomalies into it. The anomalies may be created, by the floor, ceiling, walls and furniture present in the premises, which causes reflections and interference of sound waves. The audio equipment are generally designed to replicate the sounds with good quality in studio like environment, but when they are put in real environment such as living room in a person's house, the quality of the perceived audio deteriorates, and the perceived sound is not close to the original which was recorded in the studio. Reasons for the quality reduction may include acoustics of the room, flaws in the design of audio system, and lack of knowhow to use equalizers, etc. in audio systems.

There exist several device based and program based solutions to address the problem of audio quality reduction, however, none of these solutions works in entirety. For example, the device based solutions rely on amplifiers and their connectors. However, they are expensive, add unwanted wires in the premises, and require specific connections which are typically not available in the majority of audio systems. Further, for every spot in the premises there is a need of a new device and require fairly detailed knowledge of installation and operation thereof.

The program based solutions have capability of playing back digital content but they lack consistency in providing a complete solution. For example, many programs need another program to perform required analysis. Further, they can range from free to very expensive, do not give hints to adjust frequencies for better sound, do not fix errors, require manual adjustments, can only analyze the audio, lack the capability of analyzing audio anomalies, and require fairly detailed knowledge for operation thereof.

Therefore, there exists a need for a simple and efficient solution for improving audio quality of the online multimedia content.

### SUMMARY

The present disclosure seeks to provide a method for improving audio quality of online multimedia content. The method includes sending an input audio sample to at least one speaker positioned within a premises, playing the input audio sample at the at least one speaker to produce a corresponding input audio, recording the input audio by the at least one microphone positioned in a proximity of the at least one speaker, comparing the recorded audio sample with the input audio sample for calculating acoustical characteristics of the premises and adjusting an audio quality of an online multimedia content to be played within the premises based on the calculated acoustical characteristics.

In one aspect, the calculated acoustical characteristics of the premises is an audio response of the premises.

In another aspect, the method further includes sending the audio response of the premises to an online multimedia server for enabling the online multimedia server to adjust the audio quality of the online multimedia content to be played within the premises.

In yet another aspect, the method further includes altering the audio response of the premises based on a user request.

In another aspect, method further includes retaining the audio response of the premises based on a user request.

In another aspect, the present disclosure seeks to provide a system for improving audio quality of online multimedia content. The system includes at least one speaker in a premises, a multimedia processing device configured to provide an input audio sample to the speaker and to record the input audio sample when played by the speaker, an audio processing server configured to receive the recorded audio sample to calculate acoustical characteristics of the premises from the input audio sample and the recorded audio sample, and an online multimedia service provider configured to receive the calculated acoustical characteristics for modifying audio quality of the multimedia content, which multimedia content is to be delivered by the service provider for being played in the premises.

In yet another aspect, the present disclosure seeks to provide a computer program product having a non-transitory computer-readable storage medium storing computer-executable code for improving audio quality of online multimedia content, wherein the code, when executed with a processor, is configured to cause the processor to send an input audio sample by a multimedia processing device to at least one speaker present in a premises; record the audio sample, by the multimedia processing device, when played by the at least one speaker; and forward the recorded audio sample to an audio processing server for calculating acoustical characteristics, and for sending the audio response to an online multimedia service provider, for the online multimedia service provider to modify audio quality of the multimedia content, which multimedia content is to be delivered by the online multimedia service provider for being played in the premises.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of a system for improving audio quality of an online multimedia content, in accordance with an embodiment of the present disclosure;

FIG. 2 is an illustration of a method for improving audio quality of the online multimedia content, in accordance with an embodiment of the present disclosure;

FIG. 3 is an illustration of an exemplary frequency response graph of a recorded audio sample, in accordance with an embodiment of the present disclosure;

FIG. 4 is an illustration of an exemplary frequency response graph based on an audio response of the premises, in accordance with an embodiment of the present disclosure;

FIG. 5 is an illustration of an exemplary user interface of a multimedia processing device for improving audio quality of the online multimedia content, in accordance with an embodiment of the present disclosure; and

FIG. 6 is an illustration of an exemplary user interface of a multimedia processing device provided by an online multimedia server, in accordance with an embodiment of the present disclosure.

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

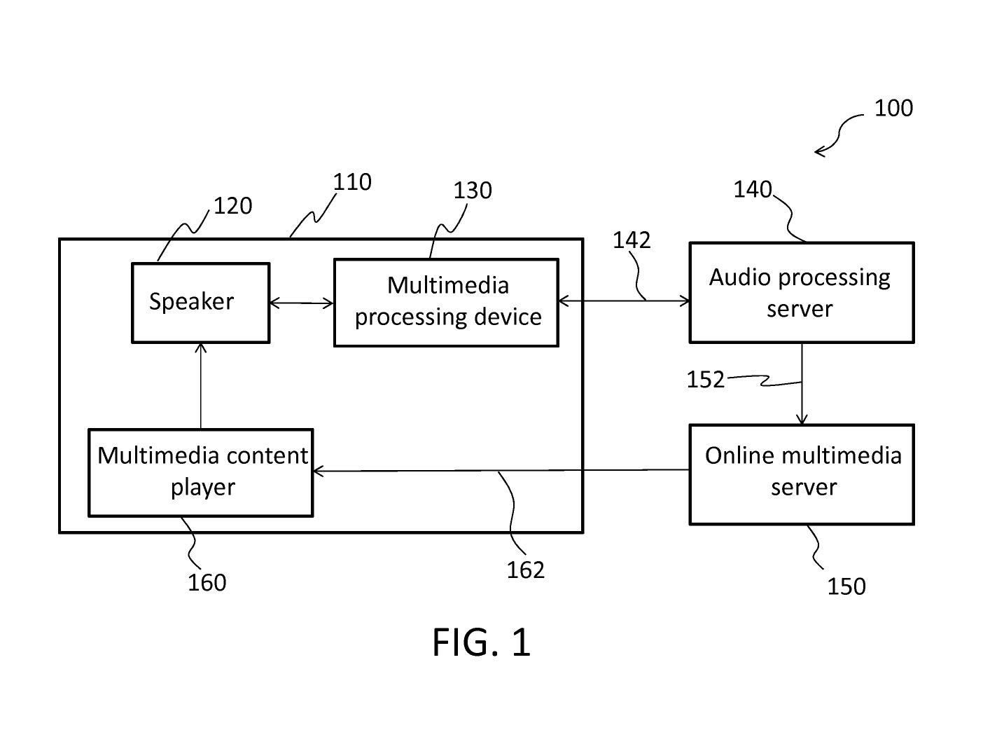

FIG. 1 is an illustration of a system 100 for improving audio quality of online multimedia content, in accordance with an embodiment of the present disclosure. The system 100 includes a speaker 120 and a multimedia content player 160 connected to the speaker 120, within a premises 110. The premises 110 is generally an enclosed area capable of enclosing the sound of an audio sample when played within the premises 110. For example, the premises 110 is a room or any enclosed area of a business or a residence structure. The premises 110 can also be a space like a car or other vehicle. The speaker 120 is generally a loudspeaker and the multimedia content player 160 is generally an interactive device capable of playing online multimedia through the speaker 120. Examples of the multimedia content player 160 include, but are not limited to, a computer, a stereo system, a television connected to a Set-Top Boxes (STBs), a PLAYSTATION® box, and a smart TV with IPTV capabilities.

The system 100 further includes a multimedia processing device 130 connected to the speaker 120. The multimedia processing device 130 is positioned within the premises 110, and is preferably in proximity of the speaker 120. Examples of the multimedia processing device 130 include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers and large-sized touch screens with embedded PCs. In one embodiment, the speaker 120 is connected to the multimedia processing device 130 through a wireless connection such as Bluetooth. In another embodiment, an audio connector of the multimedia processing device 130 is connected to the speaker 120. Alternatively the multimedia processing device 130 can be connected to the speaker 120 via multimedia content player 160.

The system 100 further includes an audio processing server 140 communicatively coupled to the multimedia processing device 130 through a communication network 142. The communication network 142 can be a wired, wireless, or a combination thereof. Examples of such communication network 142 include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks. The audio processing server 140 is further communicatively coupled to an online multimedia server 150 through a communication network 152, similar to the communication network 142 as explained above. The online multimedia server 150 is further communicatively coupled to the multimedia content player 160 through a communication network 162, similar to the communication network 142 explained herein above.

The audio processing server 140 is a device capable of processing audio signals. In one embodiment, the audio processing server 140 is capable of comparing one or more audio samples for calculating acoustical characteristics of the premises 110, which is further explained in detail. In another embodiment, the audio processing server 140 is capable of adjusting/modifying a number of audio attributes of audio signals, the audio attributes being selected from the group consisting of amplitude, frequency response (EQ), sound limiting or compression to reduce or eliminate distortion, phase cancellation and speed.

The online multimedia server 150 includes a wide range of multimedia content and is configured to process such multimedia content. Specifically, the online multimedia server 150 can be a server of an online multimedia content service provider. For example, the online multimedia server 150 can be a server of an online audio content provider, such as SPOTIFY® and Internet radio stations; or a server of an online video content provider, such as such as NETFLIX® and YOUTUBE®.

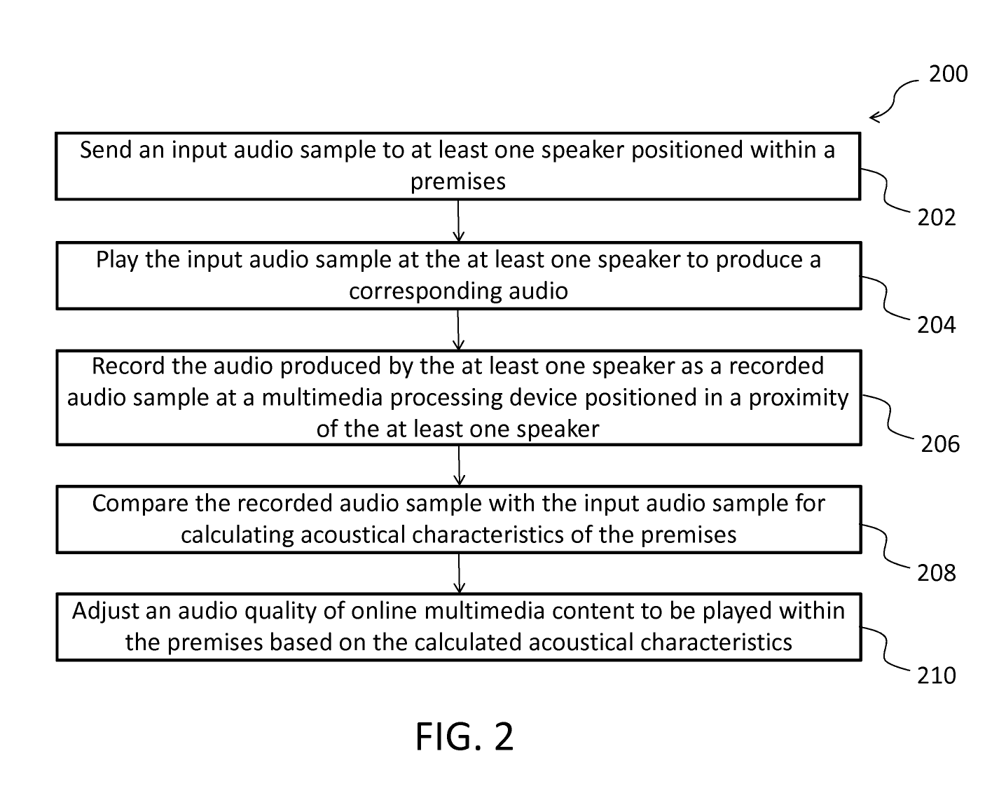

Referring now to FIG. 2, the method 200 for improving audio quality of online multimedia content is illustrated. The method 200 has been illustrated with reference to the system 100 as described in conjunction with FIG. 1.

At a step 202, an input audio sample is sent to at least one speaker, such as the speaker 120, positioned within a premises, such as the premises 110. In an embodiment, the audio processing server 140 can provide a client application to the multimedia processing device 130. The client application in the multimedia processing device 130 is used for providing the input audio sample to the speaker 120 on a user request or at the request by the audio processing server 140. The client application can be a standalone application or it can be controlled and executed by the audio processing server 140. The user can be a user of the multimedia processing device 130, desirous to listen to at least an audio section of the online multimedia content within the premises 110. In another embodiment, the input audio sample is sent to the speaker 120 by the multimedia content player 160. The sample to the multimedia content player 160 can originate from the multimedia processing device 130, the audio processing server 130 or other external service. The audio sample can have variety of formats, such as MP3, MP4, WMA, PCM and the like. Examples of the audio samples include sinusoidal sweep, impulse function, step functions etc.

In an exemplary embodiment, in order to receive online multimedia content with improved audio quality from the online multimedia server 150, the audio processing server 140 employs a software product that is configured to cause or enable a processor or controller to display a user interface on the multimedia processing device 130. The software product can be implemented by way of a native software application, or a software application running on a browser, or a plug-in application provided by a website, such as a social networking website. The software product will generally include machine-readable instructions that when executed by a processing device such as a processor or computer, will cause the processing device to perform the processes generally described herein.

At a step 204, the input audio sample is played at the speaker 120. The input audio sample is played out at the speaker 120 in real-time or close to real-time when the input audio sample is received by the speaker 120. The speaker 120 plays the input audio sample to produce a corresponding audio within the premises 110.

At a step 206, the audio sample played by the speaker 120 is recorded as a recorded audio sample by a microphone of the multimedia processing device 130. It is to be understood that, the multimedia processing device 130 is capable of both simultaneously sending the input audio sample to the speaker 120 and recording the corresponding audio produced by the speaker 120. The recording is done preferably at the proximity of the desired listening position/spot.

At a step 208, the recorded audio sample is sent to the audio processing server 140 and is compared therein with the input audio sample for calculating acoustical characteristics of the premises. The acoustical characteristics of the premises 110 primarily depend on the acoustical elements of the premises such as the space, floor, ceiling, walls and the objects present in the premises 110. Additionally, the acoustical characteristics of the premises 110 depend on the performance of the speaker 120. The calculated acoustical characteristics of the premises 110 is an audio response of the premises 110. One exemplary audio response is a transfer function derived from the input audio sample and the recorder audio sample.

At a step 210, an audio quality of online multimedia content, to be played within the premises 110, is adjusted based on the calculated acoustical characteristics or audio response of the premises 110. The online multimedia content can be either an audio content or a video content depending on the type of the online multimedia server 150 (which can be an online audio server or an online video server). In one embodiment, the audio processing server 140 sends the audio response to the online multimedia server 150, which in turn, adjusts the audio quality of online multimedia content to be played within the premises 110 based on the audio response.

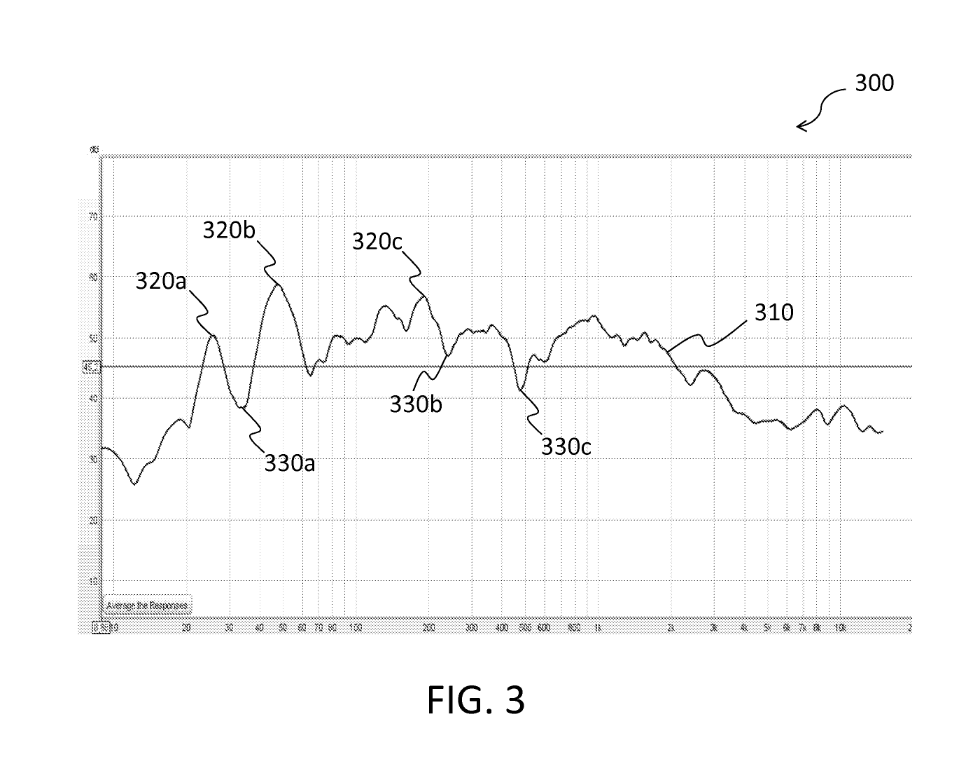

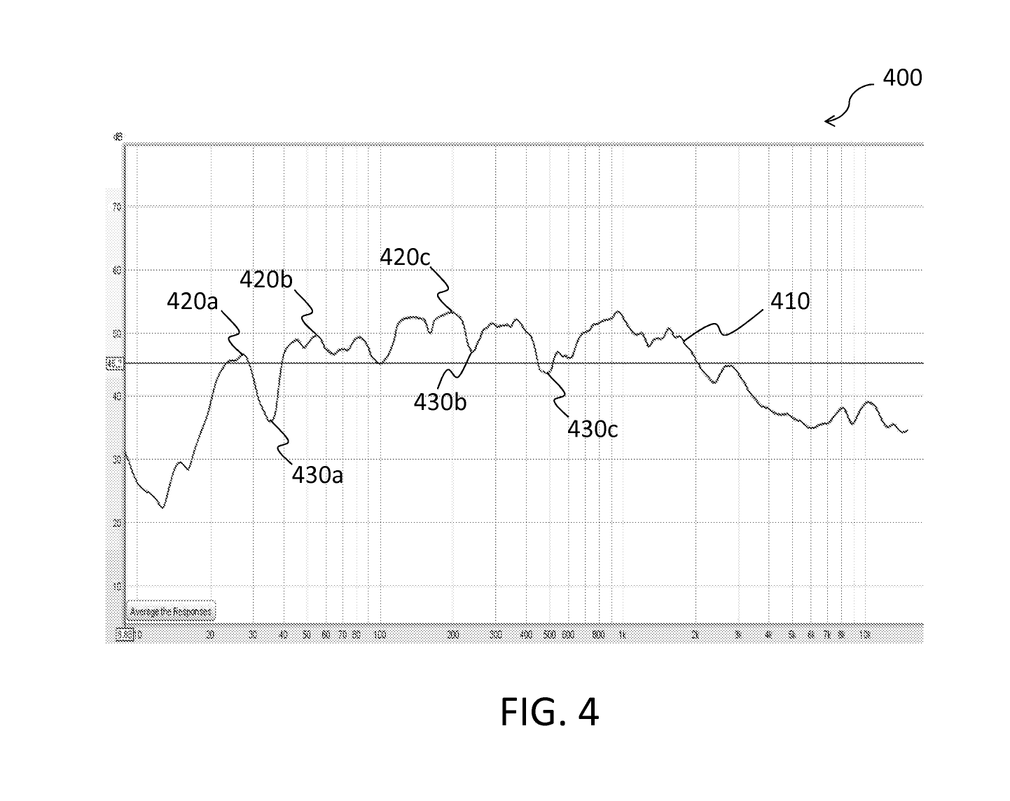

In another embodiment, the online multimedia server 150 sends the online multimedia content with the improved audio quality to the multimedia content player 160 for playing it within at the premises 110 through the speaker 120. This enhances the audio quality experience in the premises 110, as the online multimedia content with the modified audio quality takes into account, the acoustical characteristics of the premises 110. In yet another embodiment, the online multimedia server 150 sends the online multimedia content with the improved audio quality to the multimedia processing device 130 for playing it within the premises 110. The multimedia processing device 130 may play the online multimedia content using the speaker 120. The modification of the online multimedia content to have improved audio quality is further explained in detail in conjunction with FIGS. 3 and 4.

It should be noted here that the steps 202 to 210 are only illustrative and other alternatives can also be provided where one or more steps are added, one or more steps are removed, or one or more steps are provided in a different sequence without departing from the scope of the claims herein.

Referring now to FIG. 3, illustrated is an exemplary frequency response graph 300 of the recorded audio sample. Specifically, the graph 300 represents a sound wave 310, preferably in the audible spectrum, of the recorded audio sample which is recorded by the multimedia processing device 130 when the input audio sample is played by the speaker 120 in the premises 110. The sound wave 310 includes a plurality of peaks, such as peaks 320a, 320b and 320c (representing the maximum transfer of energy to the microphone of the multimedia processing device 130). The sound wave 310 also includes a plurality of valleys, such as valleys 330a, 330b and 330c (representing the minimum transfer of energy to the microphone of the multimedia processing device 130). The sound wave 310 of recorded audio sample is compared with a sound wave (not shown) of the input audio sample by the audio processing server 140 for determining the audio response, which is based on the acoustical characteristics of the premises 110.

Referring now to FIG. 4, illustrated is an exemplary frequency response graph 400 based on an audio response of the premises 110. The graph 400 represents a sound wave 410 which is suitable for the premises 110 and is based on the acoustical characteristics the premises 110. Specifically, the sound wave 410 is devoid of the audio anomalies (which can be measured from the acoustical characteristics) present in the premises 110. Typically, the audio anomalies are created based on the acoustical elements of the premises 110, such as the space, floor, ceiling, walls and objects present in the premises 110, by adding reflections and interference to a sound wave which enhances some frequencies. Also, the audio anomalies may be created by poor performance of a speaker, such as the speaker 120.

As shown, the sound wave 410 includes a plurality of peaks, such as peaks 420a, 420b and 420c (less sharper compared to the peaks 320a, 320b and 320c); and a plurality of valleys, such as valleys 430a, 430b and 430c (less sharper compared to as the valleys 330a, 330b and 330c). The sound wave 410 represents the audio response of the premises 110 with removed sharp peaks and valleys (the audio anomalies). Accordingly, the frequency response graph 400, which is based on the acoustical characteristics of the premises 110, may be considered by the online multimedia server 150 for improving audio quality of the multimedia content while sending multimedia content to the multimedia content player 160 for playing the content within the premises 110.

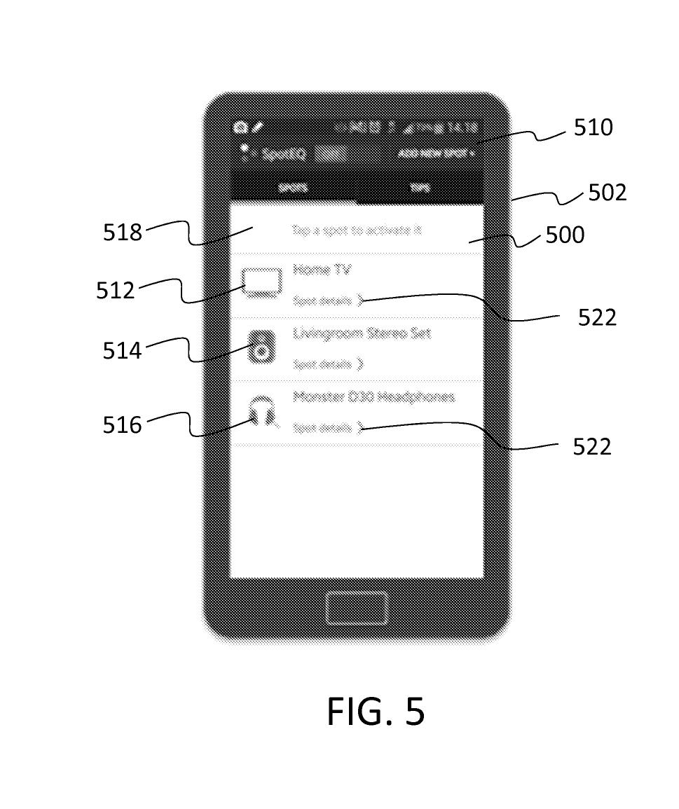

Referring now to FIG. 5, illustrated is a user interface 500 of a multimedia processing device 502 for facilitating improvement of audio quality of online multimedia content playing at audio systems of the user premises. The multimedia processing device 502 is similar to the multimedia processing device 130 of the system 100 present in the premises 110. The user interface 500 provides various user-selectable options to a user associated with the multimedia processing device 502.

The user interface 500 displays multiple spots/audio systems in the user premises, that can be registered with the audio processing server for outputting an audio of improved quality. A first spot 512 ‘home TV’ indicates a speaker of a home TV, a second spot 514 livingroom stereo set' indicates a stereo set placed in a living room, and a third spot 516 ‘monster D30 headphones’ indicates headphones. The user interface 500 includes an icon 510 “add new spot” for adding a new spot to the existing list of spots, and an icon 518 to activate an spot of the existing list of spots. The spot details against each spot enable the user to define the premises, in which the selected spot is positioned. For example, the premises can be a bed room, a living room, and the like.

In an embodiment, when the user activates a spot such as the first spot 512 by tapping on corresponding icon, the corresponding audio processing server 140 enables the multimedia processing device 502 to send an input audio sample to the speaker 512 of home TV placed in a bedroom. The speaker 512 then plays the input audio sample, and the multimedia processing device 502 records the input audio sample therein. The multimedia processing device 502 then sends the recorded audio sample to the audio processing server 140 for determining an audio response of the bedroom. The audio processing server 140 sends the determined audio response to an online multimedia server 150, which in turn uses the audio response to modify the audio quality of online media content streamed to the home TV associated with the speaker.

The user interface 500 enables the user to save a measured audio response for a particular premises such that the entire process for measuring the audio response is not required to be performed for each time when said particular premises is used, and the online multimedia server 150 can use such audio response for improving audio quality of multimedia content before streaming online multimedia content to such premises. The user interface 500 further enables the user to alter the audio response of the premises based on their requirement. For example, when the audio response of the premises is not changed for a substantial time period or when there is a substantial change in terms of setting of objects present in the premises, the user may submit a request for re-measurement of the audio response of the premises.

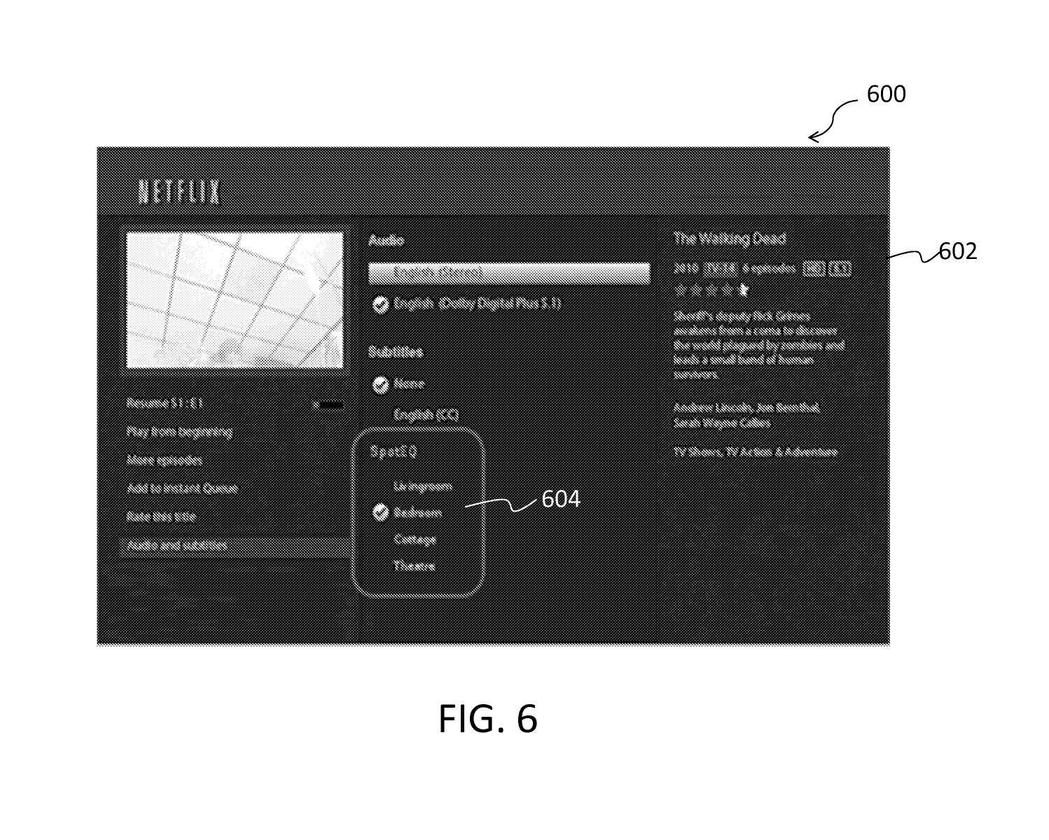

Referring now to FIG. 6, illustrated is an exemplary user interface 600 of a multimedia content player 160 displaying a web page 602 of an online multimedia server such as online multimedia server 150. The web page 602 is provided by an online video content provider NETFLIX® and includes a plug-in 604 of the audio processing server 140. The web page 602 enables the user to select a video for streaming, and the plug-in 604 enables the user to select a premise (living room, bed room cottage and theatre) in which the selected video would be played. Based on the selected premise, the audio processing server 140 may provide a corresponding measured audio response to the online multimedia server 150, for allowing the online multimedia server 150 to improve an audio quality of corresponding online video content before streaming the online video content in the selected premises.

The present disclosure provides a method, a system and a computer product for improving audio quality of online multimedia content. Specifically, the present disclosure provides a simple, efficient and cost effective solution for improving audio quality of the online multimedia content, such that a user can experience improved audio experience. The present disclosure can address audio anomalies generally associated with acoustical elements of the premises. The present disclosure not only enhances the audio experience for the entire premises but also optimizes audio experience with respect to a particular area or a spot, such as couch or sofa, present in the premises. Moreover, a user can simultaneously play a same audio in different premises based the audio responses of the different premises.

In an example, the present disclosure provides a system that enables a multimedia content service provider to provide online multimedia content with improved audio quality based on a user requirement, i.e., primarily based on the acoustical characteristics of the user's premises. Alternatively, the present disclosure can provide a multimedia content service provider which can improve audio quality of online multimedia content based on a user request. Additionally, the present disclosure can provide computer program having instructions that, when either accessed and/or executed by the multimedia processing device, the online multimedia server or the multimedia content player, cause the audio processing server to perform the method as described in conjunction with FIG. 2.

Embodiments of the present disclosure can provide a computer program product including a non-transitory machine-readable data storage medium having stored thereon program instructions that, when accessed and/or executed by a multimedia processing device, cause the audio processing device to perform the method as described in conjunction with FIG. 2.

Further embodiments of the present disclosure can be used to determine an acoustical model for a fixed premises such as a car, standard room such as hotel room, headphones. As an example the model created for a premises such as a car of certain model and make can be used for all same or substantially same cars when modifying the audio. In other words a pre-measured equalization model can be applied to same or substantially similar premises.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A method of improving an audio quality of online media content to be played by a speaker based on an audio characteristic of a premises, the method comprising:
sending an input audio sample to at least one speaker positioned within the premises;
playing the input audio sample at the at least one speaker to produce an audio output signal;
recording the audio output signal at a multimedia processing device to generate a recorded audio sample, the multimedia device being positioned in a proximity of the at least one speaker;
comparing the recorded audio sample with the input audio sample for calculating acoustical characteristics of the premises; and
adjusting an audio quality of an online multimedia content to be played within the premises based on the calculated acoustical characteristics.

2. The method as set forth in claim 1 wherein the calculated acoustical characteristics of the premises is an audio response of the premises.

3. The method as set forth in claim 2 further comprising sending the audio response of the premises to an online multimedia server, for enabling the online multimedia server to adjust the audio quality of the online multimedia content to be played within the premises.

4. The method as set forth in claim 2 further comprising altering the audio response of the premises based on a user request.

5. The method as set forth in claim 2 further comprising retaining the audio response of the premises based on a user request.

6. The method as set forth in claim 1, wherein adjusting the audio quality comprises modifying at least one audio attribute of the online multimedia content, wherein the at least one attribute comprises an amplitude, a frequency response, a sound limiting or compression to reduce or eliminate distortion, a phase cancellation and a speech.

7. The method as set forth in claim 1, wherein the online multimedia content comprises one or more of audio content and video content.

8. The method as set forth in claim 1, wherein the method is excuted by a processor that has a set of non-transitory machine executable instructions stored thereon, which, when executed by the processor cause the processor to perform the method.

9. The method as set forth in claim 1, wherein the online multimedia content with the adjusted audio quality is played by the speaker.

10. The method as set forth in claim 1, wherein a sound wave of the recorded audio sample is compared with a sound wave of the input audio sample to determine an audio response for calculating the acoustical characteristics of the premises.

11. The method as set forth in claim 10, wherein the sound wave of the input audio sample is devoid of audio anomalies.

12. A system for improving audio quality of online multimedia content based on acoustical characteristics of a premises, the system comprising:
at least one speaker;
a multimedia processing device configured to provide an input audio sample to the speaker and to record the input audio sample when played by the speaker;
a server configured to receive the recorded audio sample and calculate the acoustical characteristics of the premises from a comparison of the input audio sample and the recorded audio sample; and
an online multimedia server configured to receive the calculated acoustical characteristics and modify an audio quality of the online multimedia content based on the calculated audio characteristics as it is played by the speaker.

13. The system according to claim 12, wherein the calculated acoustical characteristics of the premises is an audio response of the premises.

14. The system according to claim 13, wherein the online multimedia server is configured to receive the audio response of the premises and adjust the audio quality of the online multimedia content to be played within the premises.

15. The system according to claim 13, wherein the online multimedia server is configured to alter the audio response of the premises based on a user request.

16. The system according to claim 12, wherein the online media server is configured to adjust the audio quality of the online multimedia content by adjusting one or more of an amplitude, a frequency response, a sound limiting or compression to reduce or eliminate distortion, a phase cancellation and a speech.

17. The system according to claim 12, wherein the online multimedia content comprises one or more of audio content and video content.

18. The system according to claim 12, wherein the online multimedia content with the modified audio quality is played by the speaker.

19. The system according to claim 12, wherein a sound wave of the recorded audio sample is compared by the server with a sound wave of the input audio sample to determine an audio response for calculating the acoustical characteristics of the premises, wherein the sound wave of the input audio sample is devoid of audio anomalies.

20. A computer program product comprising a non-transitory computer-readable storage medium storing computer-executable code for improving audio quality of online multimedia content played by a speaker in a premises, wherein the code, when executed with a processor, is configured to cause the processor to:
send an input audio sample by a multimedia processing device to at least one speaker present in the premises;
record the input audio sample, by the multimedia processing device, when played by the at least one speaker;
forward the recorded audio sample to an audio processing server;
compare the recorded audio sample to the input audio sample;
calculate the acoustical characteristics of the premises based on the comparison, and
modify an audio quality of the online multimedia content before it is played in the premises based on the calculated acoustical characteristics of the premises.
